(19) United States
(12) Patent Application Publication
(10) Pub. No.: US 2004/0186743 A1
(43) Pub. Date: Sep. 23, 2004

(54) System, method and software for individuals to experience an interview simulation and to develop career and interview skills

(76) Inventor: Angel Cordero JR., Brooklyn, NY (US)

Correspondence Address: PROFESSIONAL HIRING TOOLS, LLC, 16 PENHALE PASSAGE, MEDFORD, NJ, 08055, US

(21) Appl. No.: 10/764,575

(22) Filed: Jan. 27, 2004

Related U.S. Application Data
(60) Provisional application No. 60/442,669, filed on Jan. 27, 2003.

(51) Int. Cl. G06F 17/60

(52) U.S. Cl. 705/1

(57) ABSTRACT

The present invention provides a system, method and software for individuals to experience an interview simulation and develop career and interview skills. It allows individuals to experience a full interview simulation, including pre- and post-interview stages. The invention allows individuals to communicate with a computer generated interviewer character. It simulates a discussion by speaking to the individual and asking the individual job-related questions, and displays output on the computer terminal and/or digitizes statements into speech. The individual responds to the statements by typing replies and/or speaking replies into a device such as a microphone, video camera or telephony device that receives and records the responses onto the system. Once the interview is complete, the individual can review all his/her responses via a customized computer interface. The invention allows organizations to screen potential employees by conducting initial screening interviews. It allows individuals to self-screen by seeing which jobs they would be interested in and by submitting pre-screened data to employers. Finally, it allows individuals to train for interviews by going on realistic practice job interviews. The invention is able to provide detailed analysis and recommendations regarding the practice interviews to users, which assists them in developing career and interview skills.

### RELATED APPLICATIONS

This application claims priority to U.S. Provisional Patent Application Serial No. 60/442,669, filed on Jan. 27, 2003, the disclosure of which is herein incorporated by reference.

### FIELD OF THE INVENTION

The present invention relates in general to the field of interactive software and more particularly to a system, method and software for providing interactive employment interviews, automated employment screening, employment interview training, speech training, career training, and employment interview preparation.

### BACKGROUND OF THE INVENTION

Organizations spend excessive amounts of time and money interviewing candidates for employment. Although they use a variety of timesaving techniques such as phone interviews and paper exams, these techniques do little to curb the high cost of interviewing candidates. Moreover, staffing agencies boast of providing value-added services, but in the end only provide resumes with practically no useful verification. Candidates also spend a tremendous amount of time searching and interviewing for jobs, yet often find that they are either unlikely to secure the position because they are unqualified for the position or they do not wish to pursue it.

There is, therefore, a need for a system, method and software for organizations to automate the process of interviewing and screening candidates. The present invention allows organizations to process candidates through an automated interviewing tool that can determine which are the best candidates to bring in for live interviews. There is also a need for a system, method and software for candidates to pre-screen themselves to determine which jobs to apply for and to create additional resources for candidates to market themselves to employers. The present invention allows individuals to perform virtual interviews that can be analyzed for qualifications and submitted to employers for screening purposes.

Furthermore, in an increasingly competitive job market where candidates share similar skill sets and experience, the interview becomes the deciding factor in the hiring process. In the current environment, individuals do not have the means to sufficiently practice job interviews. At best, individuals can practice interviews with a live person. However, most individuals have very limited access to such a person due to cost, time and availability constraints. Inferior substitutes include interview question books, online sites with generic questions, interview tactics workshops, interview videos, and computer based training for a particular skill set.

There is, therefore, a need for a system, method and software for individuals to rehearse their interviewing skills. The present invention allows individuals to practice, develop, and refine their interviewing skills. Individuals can practice an interview as many times as they wish from any location with access to a computer.

Previous patents have focused on the ability to communicate in text and in speech with a computer, interactive learning, virtual characters, synthesized speech and expert systems, but no patent combines these concepts and/or new concepts into a system, method and software for interactive employment interviews used for screening and training. The present invention solves the need for this technology.

### SUMMARY OF THE INVENTION

The present invention relates to interactive software and provides a system, method and software for individuals to experience an interview simulation. It allows organizations to create generic and job specific interviews that can be administered in an automated manner to job applicants for screening purposes. The present invention also allows job seekers to screen themselves and provide pre-screened interview data to employers. Finally, the present invention provides a means for individuals to develop career and interview skills by learning about and practicing for generic and job-specific interviews.

Interviews can be conducted locally, they can be conducted remotely by utilizing a remote server computer. Interviews can be conducted on a computer or any other device that can process the software. Such devices may include one or more of the following input/output devices: keyboard, microphone, video camera, web camera, sound card, video card, modem connection, network connection, local area network connection, metropolitan area network connection, wide area network connection, intranet connection, and wireless network connection.

The system, method and software utilize pre-interview and post-interview data that is incorporated into the interview simulation and analysis. Examples include but are not limited to the resume, employment application, choice of character, clothing, job research, traveling, interpersonal interactions within a company, salary negotiations, and post interview correspondence.

The system, method and software allow individuals to communicate with one or more software-generated animated interviewers. Communication is bi-directional. The software can speak to the individual by displaying statements on the computer terminal and/or digitizing output into sound. The individual responds to the interviewers by typing and/or speaking statements into a device such as a microphone or video camera that records and translates the responses into the system.

The system, method and software are able to simulate an interview conversation based on a dynamic interview plan and internal expert system. This allows a user to experience a series of interconnected discussions that create an interview discussion as a whole.

The system, method and software are capable of producing a large number of generic and job-specific questions related to the type of interview in which the user has chosen. These questions can also be proposed in response to previous interview questions and responses.

The system, method and software provides detailed screening, review, analysis, and feedback for all stages of the interview simulation and displays results using a customized computer interface on the computer terminal. The screening and analysis evaluates all input including pre-interview, interview, post-interview, explicit and implicit data. Screening and analysis also produces a series of recommendations based on the interview interaction. The recommendations can be provided to hiring managers for screening purposes, or directly to the user if used for training purposes. The format of the recommendations can change based on the needs of the organization and user. The system also suggests additional external help resources based on the needs of the user and uses an algorithm to match the needs of the user with a database.

The system allows for full customization of the interview simulation, either for screening or for training. This includes but is not limited to the editing and configuration of company information, interview rooms, interviewer profiles, job information and requirements, classified ads, interview agendas, testing data, and industry knowledge.

### BRIEF DESCRIPTION OF THE DRAWINGS

These and other features, aspects, and advantages of the present invention may be better understood by referring to the following description in conjunction with the accompanying drawings in which:

FIG. 1. is a block schematic diagram which outlines how the employment interview system is composed of sub systems and databases.

FIG. 2. is a block schematic diagram which gives insight into how text, speech, graphics, and environment events interact.

FIG. 3. is a block schematic diagram which explains how expert systems can cooperate to implement a job interview discussion simulation.

FIG. 4. is a block schematic diagram that outlines how a user chooses a job and how the job data is used to drive the interview simulation.

FIG. 5. is a block schematic diagram that outlines how job-seekers and employers utilize the system to find each other.

FIG. 6. is a block schematic diagram that displays how different types of clients, including different communication protocols and platforms, are supported by the system.

FIG. 7. is a block schematic diagram that explains how the employment interview system can be extended beyond job interviews with other types of knowledge and information.

FIG. 8. is a block schematic diagram that displays how the employment interview system transmits interview data to the system and employers.

FIG. 9. is a block schematic diagram which explains how the interview system supports telephone, Voice over IP (VoIP) and video phone clients.

FIG. 10. is a block schematic diagram that displays how the interview system can be administrated remotely and how interviews can be coordinated by live interviewers.

### DETAILED DESCRIPTION OF THE PREFERRED EMBODIMENT

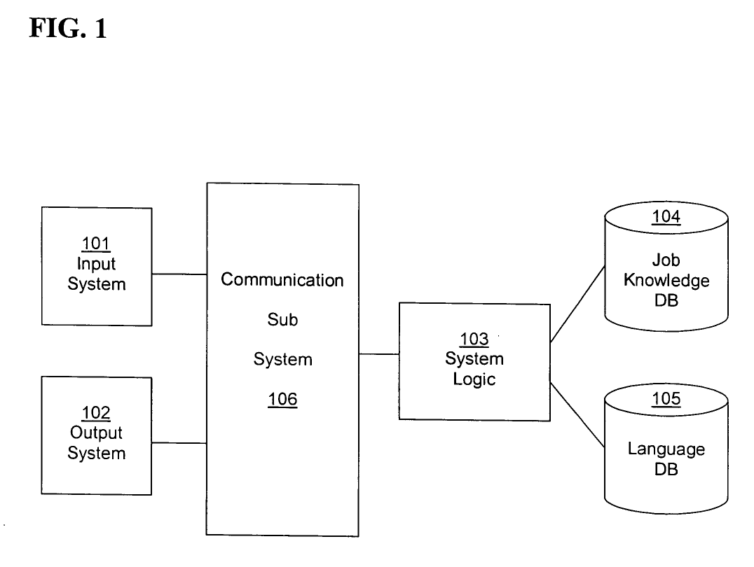

Introduction to the Employment Interview System: The high-level employment interview system is seen in FIG. 1. This system has an input system (101) that is responsible for receiving and managing input from the user. This input can be in the form of text, speech, video data, or hardware events such as mouse or keyboard actions. Not all input is in the form of communications. Some input can be in the form of a control event, such as asking the interviewer to proceed to the next question, or having a virtual character express sadness during a salary negotiation. The input data consisting of video data can be a live video feed of the user speaking and reacting to the interviewer, exactly as in what would be expected of in a real job interview. The user may be able to speak into the system using a microphone. The speech data can be processed in a variety of ways. First, the speech data may be used in its original form to be stored and reviewed later by the user or other interested parties. The speech data may also be streamed into a speech recognition system, followed by syntax, and application domain tweaking, and then fed into a natural language parser to extract desired input phrases. The output system (102) includes the visual aspects as well as the audio aspects of the interview. The visual aspect may include a direct video feed from a remote interviewer, or a computer generated representation of one or more interviewer characters. When using a computer generated scene it is likely that the user will also be able to see environments such as an interview room and desk. The audio aspects include voices of the interviewers as well as closed captioning text if desired. The system logic (103) utilizes a set of logic routines to manage the interview discussion. These discussion management routines utilize a set of specialized state machines and expert systems for various aspects of the interview. Though they cannot handle all conversations perfectly, they do have enough logic to handle a wide range of interview discussion topics when supported by appropriate databases. The two key databases are the job knowledge database (104) and the language database (105). The job knowledge database contains information about job descriptions, human resources, and job specific information such as skill files, which contain questions, answers, analysis, and scores. The language database contains language specific information such as dictionaries, synonyms, pronunciation rules, and other information related to natural language processing. Finally, depending on the exact use of the system it is possible to have a communications subsystem (106), which would allow an interviewer to be detached from the interview system. This configuration may be useful when the user of the interview system is on a telephone, videophone, or a remote computer on a network.

Interview System for Employers: Employers may want to directly incorporate the interview system to help interview corporate applicants. The employer may be a direct employer or an intermediary employment agency that is seeking to identify qualifying candidates. In either case the employer may use the system to interview candidates. The system can be configured in such a way that the employer provides the job knowledge including an interview agenda plan and specific questions and skills to discuss. The applicant can use the system over the phone or through a computing device. The applicant may be local or at a remote site. The interview system will also allow an employer to directly control the interview with an administration tool (1003), which will allow a person at the employer to have full control of the interview discussion, and if necessary switch between an automatic interview using the expert systems and a manual interview with the employee speaking or typing into the administration tool. If the system is used to interview the candidate, the employer will receive an analysis of the applicant's performance based on information found in the job knowledge database as well as other non-qualitative information such as ability to answer quickly, ability to communicate effectively, and interpersonal skills. The system analysis can be viewed immediately by an administrator or viewed sometime in the future in the form of a report or email.

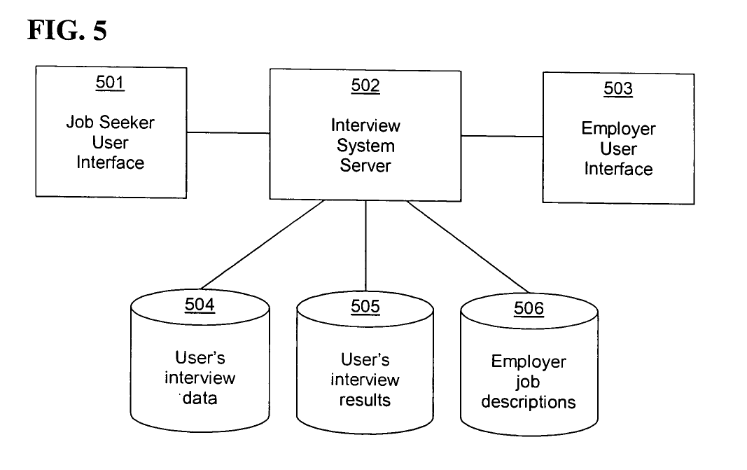

Interview Matching System: The system can be configured in a manner in which the system could have the ability to match job seekers with job opportunities. FIG. 5, depicts a matchmaking system based on the interview system presented herein. At the core of the match making system is the interview system (502), which may take form as an interview system server. The job candidate (501) will choose and go on a job interview for a well known job type or a specific open job position. Employers (503) may post job openings or may just scan the results (504, 505) of specific job seekers. Job seekers who submit their interview information when applying for a job will provide the interview system with general user data such as resume and background information (504). In addition, job seekers will provide interview results after each interview such as transcript, audio, video, and analysis. The interview match system also has a database with employer job descriptions (506). The employer job description database contains job ads and job descriptions with triggers to contact the employer if a candidate has qualified. For example, if an employer creates a job, the employer may want to be notified by email if an accountant has interviewed and has passed the minimum score for two of the five key skills in the specified job description.

Interview Training System: The interview system described herein lends itself to career development applications, in particular job interview training. The system can be used to provide practice job interviews. Several different types of interview training sessions can be made from the base interview system. First, a user can choose from the available jobs and go on a job interview. Second, the user can build a job interview based on a set of job criteria that the user selects. Third, the user may desire training in one aspect of a job interview, and the system can provide specific training in only that job area. Finally, the interactive training program will have access to all of the input and output systems of an interview training application, allowing a user to record mock interviews with another live interviewer. Since the training system has access to the job knowledge base, the system could allow the user to prepare for job interviews with information about common questions based on the job desired along with the user's experience, education, skills, and goals. The system could also show the user recommended answers when the user reviews an audio or video recording of practice interviews. As a training platform, users could also become familiarized with the stages of professional interviews, such as choosing travel options, traveling to the location, entering the corporate site, reception area or lobby, filling out an application, meeting with the human resources department, walking to the interview room, interviewing, sending post interview thank you notes, handling second interviews, and handling salary discussions. The training system can provide the user with information after textually analyzing a job application, cover letter, or resume. Since the system has a job description in the job knowledge database, the job description can highlight the skills and traits required, minimum level of education, and minimum level of experience. The training system could also not only provide a localized language user interface and help system, but it could also provide multilingual interviews based on the language database that the interview system utilizes. It is important to note that the interview training application can work on a standalone machine as well as in a network or Internet environment. The application may also be built on a wide range of languages such as C, C++, Java, Shockwave Lingo, C#, Perl, Visual Basic, and others with similar or additional capabilities. The operating systems could also be vast such as personal computer operating systems and embedded operating systems, as long as a suitable input/output system and associated interview system code can exist, or can be reached through a communications medium such as TCP/IP.

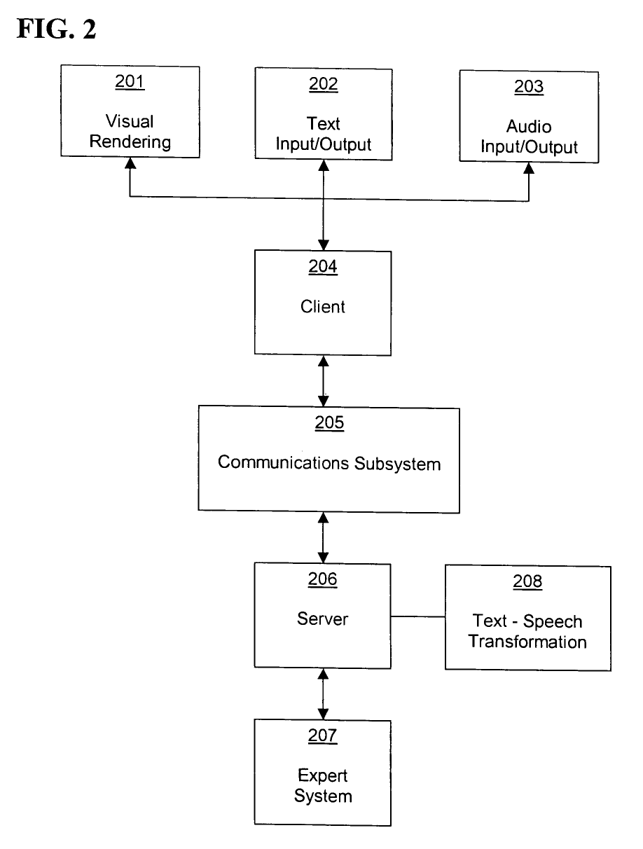

Rendering Interview Representation: Although the interview system is fully functional without a sophisticated graphics system (i.e., text based), a sophisticated graphics system could be used in conjunction with the interview system. Interviewer characters can be rendered in 2D (composite images), or 3D environment (3D objects in a space with configurable points of view). Certain applications may choose to render the interview characters with photorealistic imagery and others with less realistic animated cartoons. In either case, the invention will support a range of artistic mediums. In order to achieve animation the interview system will trigger a set of events to notify the animation system of character and sub-character states. The character states can be used to choose the appropriate graphics image or rendering. Sub-character states allow characters to move different body parts at the same time; for example the lips can be set to one state, while the body is set to another state. All character animation states are represented with a list of numbers or distinct labeled strings. The interview system determines what interviewers will say, how characters will say certain things, how characters will interpret and react to user input, how characters feel, and what high level actions characters should be performing. A sophisticated graphics system can take information from the server and render it (FIG. 2, 201) for the particular interviewer. The system may also control and render body actions; for example, looking around the room, and nodding to input when a user is talking or typing. The system has information about a virtual interviewer such as happiness and interest level, so that when the application is in an idle state, it may render an appropriate manager emotional state. The user may be rendered in 2D (composite images), or 3D environment (3D objects in a space with configurable points of view). The user view may not be in the view in the case when the user is taking a first person view. The user may be partially viewed such as in the case when the camera is over the user's shoulder, in which case the display will show the back of the head, body, and possibly hands of the user. In a 3D environment the user may or may not be fully viewed depending on the camera angle within the room. The view (i.e., camera angle and location) can be chosen automatically by a smart software camera manager based on the location of key characters, along with a collection of preferred camera positions. The view may also be selected manually by the user. Common views include first person, side view, and top view. The best view may also depend on the number of characters in the interview scene, when for example there is one interviewee and three interviewers in a corporate conference room. The user may have the choice to select and build a character to use for the interview. This may include visual and non-visual attributes. Visual attributes include gender, body type, skin color, hair color, type and amount of jewelry, clothing style, clothing colors and patterns, and others. Non-visual attributes may include cologne and perfume, and others. In certain application modes, the user will have the ability to control the character including body position, head and body gestures, and facial expressions. Facial expressions will help provide an additional level of control by allowing a user to show happiness, enthusiasm, disappointment, and other emotions that may be required during an interview. The user will have some control of explicit actions, but may have implicit control over others, such as when a user is talking into a microphone and has configured his or her character to use hand gestures, in which case the client system will automatically move hands in an appropriate manner while the user speaks. The interview rendering may utilize a simple background image, animated video background, or 3D model rendering, or a more advanced 3D rendering with animated textures. The job knowledge sent to the interview system could be used to determine the appropriate interview room environment, since information about the industry and company are available. Some examples of interview environments are a small office, conference room, and interview room in a human resources department. Environments can be used to provide a richer visual interview experience, such as when the user is able to see scenes before the interview such as the waiting room, or after the interview such as a company tour.

Management of Interview Data: When experiencing the most realistic form of interview, the user may choose to provide the system with detailed background information such as what is typically found in a job application or resume. In addition, when additional hardware is available, the interview system will have the capability to record audio through a microphone, and record video through a web camera or standard video camera. Depending on the use of the interview system, an interview analysis may also be available. In aggregate, the specific interview information will consist of background information, audio data, video data, and analysis. The specific interview information can be recorded and saved locally or remotely depending on the need. Saving the data remotely can be done in a file system or by using a network medium. The information may also be digitized, especially when recording multimedia signals. It can also be compressed using a proprietary or standard compressor for the multimedia data. In addition, the multimedia data may be combined into one digital data stream, instead of an audio and video stream. Although combined, the data stream can use two distinct compression algorithms or one algorithm. The system does not require any particular file format or compression standard, and thus is flexible in that respect. The specific interview information can also be encrypted with a user or system provided key and algorithm. The specific information may be saved and indexed to be reviewed or compared later. It is also possible for the specific interview information to be reviewed with by others in real-time or at a later time. Other interested parties may include advisors and employment agencies, and of course should be done in a way consistent with the rights of the user.

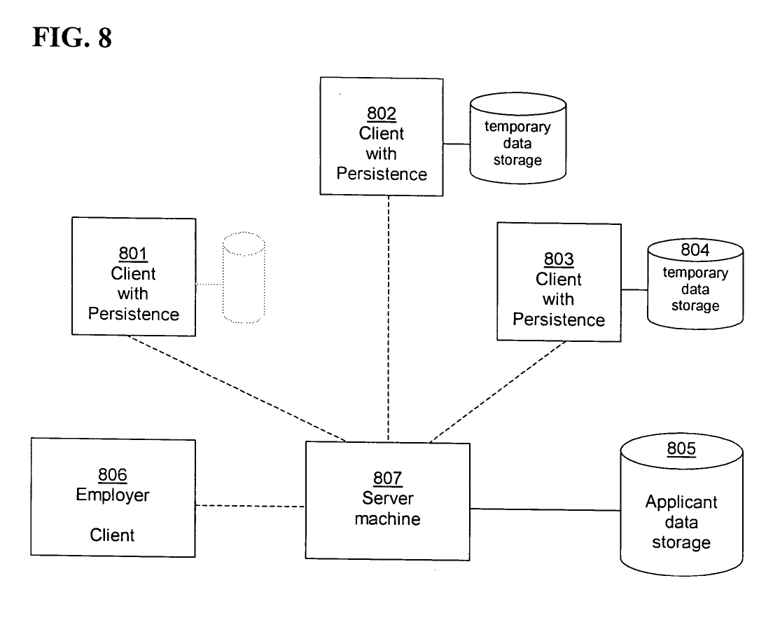

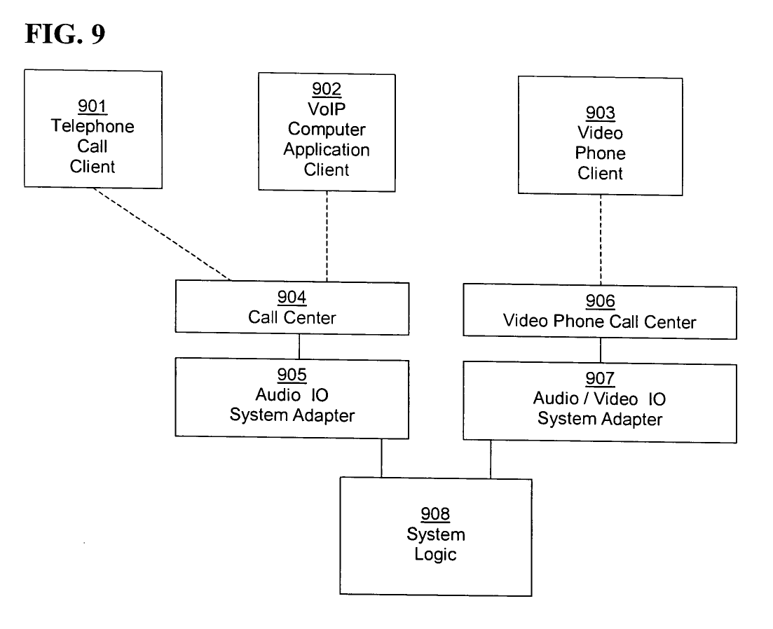

Transmitting Interview Data: As alluded to earlier, the interview system can be used to transmit the content and results of the interview to a remote location. The content could be a real-time audio or video stream to an interested party, such as an employer with an open position. FIG. 8, demonstrates how a real-time interview client (801) is sending interview data to an interview server (807). The employer (806) or other party's system can then access the interview data (805) through the interview server. The client may send real-time data because it is the desired mode of operation, or because it is incapable of storing local data. Other clients (802, 803) may have various amounts of local storage and may choose to temporarily or permanently store interview data locally. An enhanced system could utilize a wide range of networking protocols to move data from the user application. In certain configurations such as FIG. 9, it is possible to have telephone based interviews stored on the server, in which case this data could be retransmitted or converted to another format such as text transcript, and then retransmitted to an interested party. Retrieval of interview data is not only possible by third parties such as the employment agency, it is also possible by the interview clients (801, 802, 803, 901, 902, 903) when necessary.

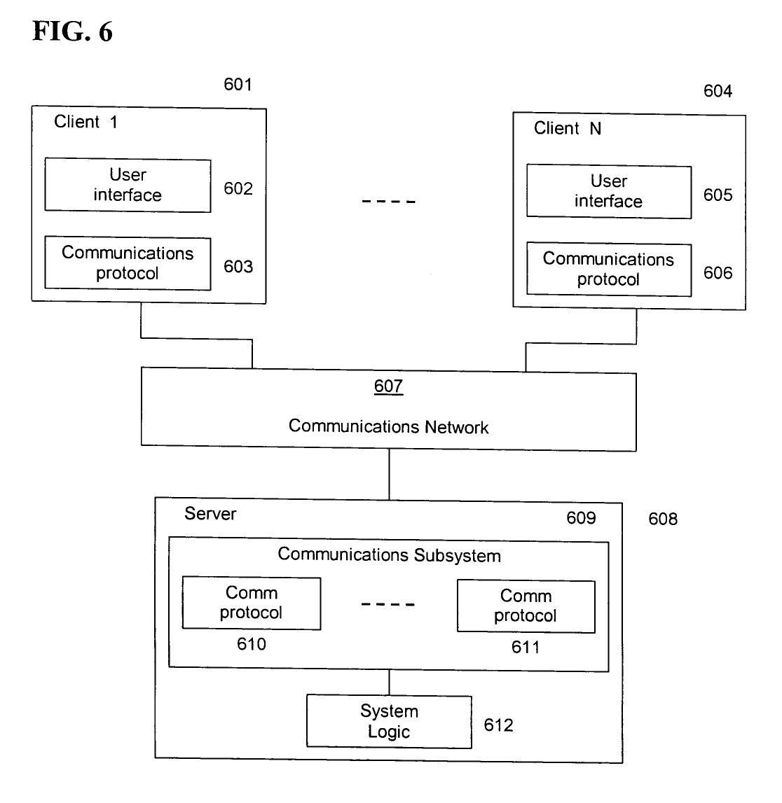

Communications and Control: When the system logic is directly connected to the user interface, the communications layer acts as a pass through mechanism. However, when the system logic is remotely connected to the user interface, the two components incorporate a communications layer FIG. 6, (607). The client and server communicate using messages. Messages are a platform independent payload that can contain a wide range of data such as strings, text, and binary. The messages can be transmitted over a wide range of communication mediums and protocols. They can be used on connection oriented systems such as TCP/IP and non-connection oriented systems such as an IPX network. Similarly, the system can be used over wired or wireless systems. The messages contain general information such as type and version information as well as a collection of message data. The most common messages contain control codes or data. Some control messages manage the communications session, such as logon to server, and disconnect from server. Some control messages handle pre-interview data such as send user information and request job information. Some control messages handle interview specific messages such as start interview, end interview, send action, and send data. Some control messages are for post interview events such as submit post-interview data and get interview results. Messages may be passed in a plaintext, encrypted, compressed, encrypted and compressed, other binary or text formats depending on the configuration. FIG. 2, shows how the server (206, 207) is able to send and receive a wide variety of speech and action events. The system utilizes text messages that contain control codes and data. Some of the messages contain speech messages represented with text characters. The client application (204) may type some text (202) that will be sent to the server as user input. The client application may also use a speech recognition component (203) that will convert speech to text, do some additional language processing, and then send the text to the server. The client application may also send pure speech to the server, and let the server handle the speech recognition process. The best formula depends on the capabilities and needs of the client and server. The server is able to generate speech messages from the hiring managers and send them to the client as audio speech messages or text messages. The client will then either show the text as closed-captioned text (202), or render the text via a text to speech component (203). Speech messages may also contain clues that may alter the modulation of speech or trigger facial or body emotions or gestures. For example text can contain an exclamation point to signal excitement. In addition, a text message could contain a code such as<disappointment> within a text string such as “I'm sorry that is wrong.” resulting in a manager character speaking and showing disappointment at the same time.

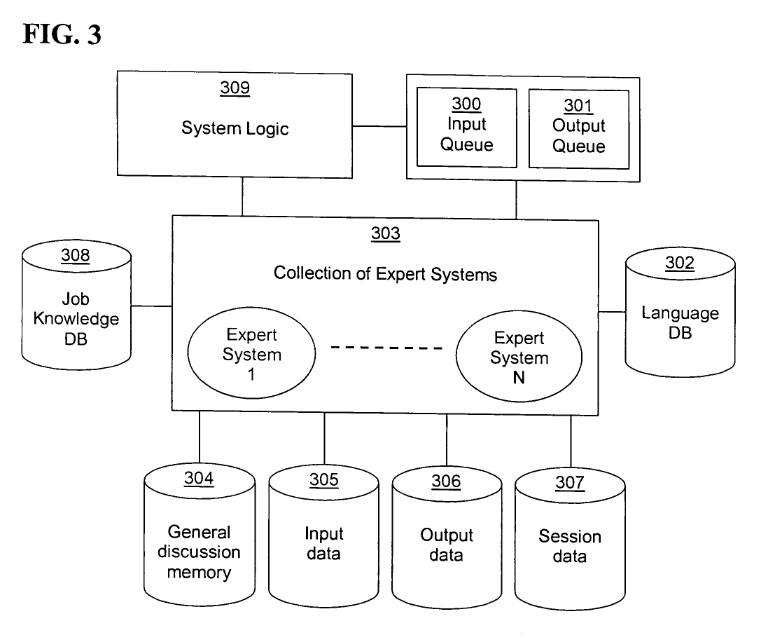

An important aspect of the messaging system is that it allows a local client or remote client with a system server to use a set of inter-connected message pipeline components for input and output. The pipeline infrastructure and components support transformation and multiple forms of data to communicate. For example the user input can communicate with the interview system in a variety of ways such as speaking with text input (202) or speaking with voice (203). The text can be packaged into one or more messages and then transferred to the system. The voice data can be packaged into one or more messages and then transferred to the system, unpacked and then processed through a variety of additional information transformation engines such as a speech recognition system to convert audio to text that can be parsed by an interview discussion engine. There may also be the configuration in which the client application may want to convert the speech to text on the local side, then use text for discussion messages which are sent to the system server for further processing as user input. The user output system also is controlled by message oriented control and data. For example, the system may send the client a phrase that an interviewer wishes to ask. In the case where there are multiple interviewers in an environment, the phrase will also be accompanied by a unique interviewer ID. The user output system may receive the phrase in the form of a text phrase embedded within a message. The client system (204) may decide to additionally render the text through a text to speech engine to supplement displayed text or replace the phrase spoken by the interviewer. The client platform may not be capable of rendering the text to speech message, in which case the client may ask the server to render the speech for it, and send it the audio stream of the interviewer phrase in addition to other text information such as lip-syncing information, phrase text, and interviewer ID. FIG. 3, shows how the discussion system has access to the input and output queues, and has a wide variety of helpers to work with the queues. For example the expert system may want to know how long has passed since the interviewee spoke last, and may refer to (304, 305). The input/output queuing mechanism can support multiple client sources and targets. The expert systems can retrieve the spoken words, whether the words were sent as text or speech. The system logic in (612) will have the ability to pre-process messages upon receiving them prior to placing them in the system input/output queues for retrieval from the expert systems. The discussion system can also use and transform a set of output data messages and control messages. This may be based on the client's preferences or limitations. One particular case is when the system server sends the client text, text and audio speech data, or speech audio data. This capability-limitations-preference model can also be applied to video, where a system server may send the client a graphics or video stream containing a configurable stream of renderings during an interview experience. This situation would require no art or sophisticated client-side graphics sub system. Alternatively clients may decide not to render graphics at all, or request that the server system send the client control messages so that a client may render an interview locally in text, 2D, or 3D. The control messages could contain specific environment events or transitional updates such as interviewer character #1 is nodding her head up and down.

Execution on Standalone or Network Device: The interview system presented can be implemented entirely on one machine, or can be partially implemented as an interview client with reliance on an interview server, which will handle the remaining system logic. FIG. 8, demonstrates how clients with different memory capabilities can access the interview server. The same principle can also be used for different client systems with little to advanced input systems. In the most simple input system, an interview training session can skip actually answering questions, and simply trigger an input event to proceed. Systems that have a little more capability such as having a few buttons or a small range of inputs, can use those inputs to answer multiple choice questions. More advanced systems will have keyboards or simulated keyboards, in addition to audio input and speech recognition capabilities. In many cases, the interview server can supplement a lightweight client by either doing work for the client or providing the client with appropriate data for that platform. The graphics interface of a network client (605) may also have a range of capabilities that can be supported by an interview server. The design of the system lends itself to be used by a wide range of computing platforms, such as standard PCs, laptop PCs, dummy terminals, kiosks, Personal Digital Assistants, and mobile phones with application support.

Interview client applications can be programmed on a variety of programming languages, and can function on a variety of operating systems. Network clients can use a variety of communications mediums (607) such as wireless and wired networks. Though some networks will have higher capabilities, for example current limitations do not effectively support video streaming over a wireless network, though it is currently possible by the client and server, as can be achieved over a LAN or common home Internet broadband connection. Interview clients and servers can use a variety of communications protocols to communicate. For example, the clients can use IP and IPX. Some protocols, such as IPX and UDP, may require additional protocol layers to guarantee data, order, and manage sessions. The clients and servers can also support higher level protocols such as TCP/IP and HTTP over TCP/IP. As long as the client and server support the same protocol, different types of network clients can use the interview server system services. A wide range of communications mediums (607) or networks can be utilized to provide a computer-based interview. Some of the many possible client/server configurations include modem to modem, modem to intranet, modem to Internet, local area network, metropolitan area network, wide area network, intranet, and wireless network. In all cases the client would use a protocol that is understood by the interview server over the specific communications network.

Interviewing Through a Phone Device: FIG. 9, Demonstrates how the interview system can be wrapped with a telephony bridge (904, 906), to support telephone based clients. These clients can use a regular line telephone, wireless telephone, voice telephone application on a computing device, or video phone using ITU H.XXX protocols. The interviews may be for training or real job seeking purposes. Since the interview is primarily using the media stream (audio and optional video), there is little dependency on the specific type of voice communications network used, other than quality of the signal and possible loss of connection. The computer based voice job interview will work over local telephone carriers, long distance carriers, wireless telephone carriers, data over Internet carriers, and other capable carriers. The specific network protocol of wireless carriers such as CDMA or GSM is not critical to the system, since the end points will use voice. The client side will initiate or receive a call from the interview server. The interview server will use telephony components to send or receive phone calls. Once the connection has been established, the server's telephony equipment can detect DTMF buttons as well as receive and transmit an audio and optional video stream. The video stream can come from computer generated imagery, where the server generates single images or multiple frames per second imagery then transmits it through the video phone call center using an audio/video 10 system adapter (907). In both cases audio is generated on the server and streamed as an audio stream (905, 907). Input audio is received and turned into chunks of discussion input and placed into the system queues for analysis by the expert systems. The user of the telephone client will experience a phone job interview. The user of the videophone client will have an experience similar that of a multimedia PC user, which is simulating a realistic job interview experience.

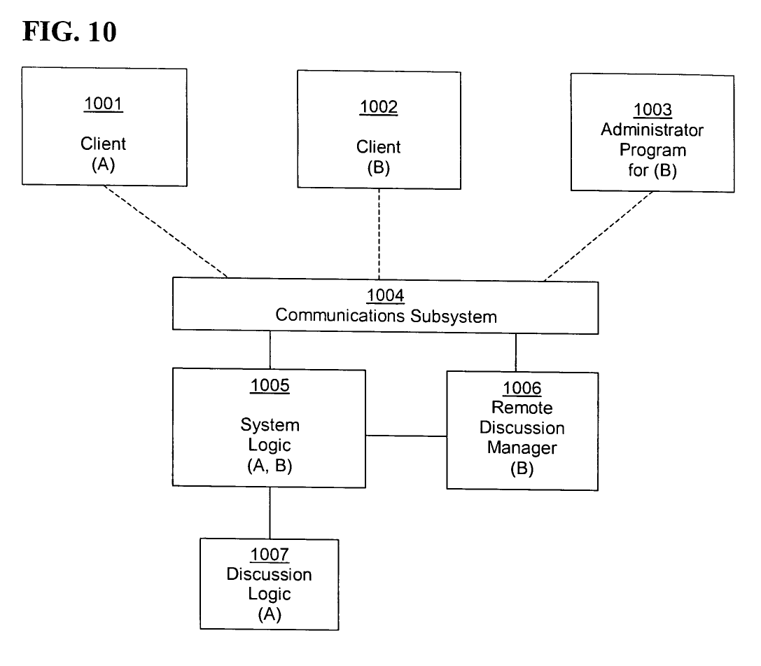

Control of a Virtual Interviewee Character: The interview system has several ways of having the user participate in the interview beyond that of the actual discussion. The interviewee can choose to use a camera to represent him or herself in the interview process. This still image or periodic rate video stream can be used to detect movement of the interviewee. An object identification and motion tracking system can be used to identify the background, head, body, and hands. To improve the capabilities of the system, the user may be asked to sit in front of the video camera at an appropriate distance, similar to that of an interview table, while simultaneously setting a helpful view and identification upper body area for the object and motion tracking system. The video stream can also be used in a rebroadcast scenario such as when re-broadcasting a previous or real-time interview to an external party as seen in FIG. 10. It may be desired to have a real interactive interview simulation where the interviewee is a character in a graphical environment with interviewers. In this case, the user can control his character directly or indirectly. A user may control his character by specifying a body position or action such as sit up, nod head, look at interviewer #2. A user may also control his expressions directly by specifying a specific emotional state such as express happiness or express disappointment. Indirectly, a user may configure his or her character to behave in a certain way, and having that automatic behavior be executed by the animation system. An example of an automatic behavior is asking the character to use hands when speaking at a certain intensity. Once specified the character will automatically use hand gestures when speaking at a frequency or intensity level previously specified by the user. A user may also specify automatic emotions, such as configuring a happiness level throughout the interview. During idle times, interviewees that are happy will automatically smile versus interviewees that are not happy will express disappointment. Advanced features could directly or indirectly control the animation and behavior that a user character portrays. For example, in a multiple interviewer interview, the user may want to directly control and focus on one interviewer, or automatically make eye contact with the various interviewers. The system could use a variety of methods to set the virtual character controls. Internally, a collection of variables for possible actions can have default automatic values or specific action specific values.

Supporting Multiple Simultaneous Interviews: In a networked environment, the interview system can support multiple simultaneous interviews. The communications system in FIG. 6, shows how several types of clients can connect to the server at the same time. To simultaneously server a multitude of clients, the server can use a scheduling algorithm, polling, or threads. These servicing algorithms can wrap the actual process of moving data and messages to and from the server. For example in a near real time TCP/IP environment, the server can be notified instantly when data has arrived. In fact, the server communications subsystem (609) may actually be sleeping or serving other clients until there is data to be read. This is also the case with most modern telephony (904, 906) hardware and programming interfaces. In both cases, the server can perform system logic, and handle a multitude of clients simultaneously. There are some clients and protocols that are connectionless or do not support events, that may require periodic messages or polling. This decision may have been preferred to support some of a specific client's design goals, such as having the ability to work from behind a personal firewall. In such a case, the client application should connect to an external TCP connection or under more secure conditions only connect to an HTTP server. The interview server can act as such an end point for an interview client, and periodically service the interview client based on periodic messages. In this case the interview client will send messages using URL parameters or POST data. The HTTP interview client will receive messages embedded inside the request HTML, perhaps in XML format. Each client that is connected to the server should be uniquely identified by the interview server. The communications subsystem, call center, or video phone call center will be responsible for providing a unique client id for the connected client. At any point the interview server will have client specific session information based on the client id. Regardless of whether a client is actively connected at the moment, a server will be able to process real time interview activities and schedule outgoing messages to be sent at real time or at the next polling message. In a more advanced configuration multiple interview servers can serve a greater load in several ways. First a DNS, or service finder server can be used by clients to find an available interview server. Second, load balancing hardware can be used in front of the interview server which will seamlessly distribute the interview clients to an array of interview servers. In both cases the interview servers can manage a client for the duration of the session while keeping client specific information in memory, harddrive, network storage, or database. The servers can also store the client specific information in a shareable location such as a network storage and database, which would allow multiple servers to service clients independent of a specific client/server binding.

Multiple Forms of Simultaneous Input and Output: In the design of the interview system it is important to note that the system not only supports a wide range of input and output options. The system also supports using multiple forms of input and output at the same time. For example, a user should be able to view the closed captioning text of an interviewer as well as hear the voice of the interviewer character speaking. In the case of multiple interviewers, the closed captioning text may provide speaker information, and the speech of the interviewers may have different pitches. The user should be able to type to communicate, speak into a microphone to communicate, or speak and type to communicate. Depending on the nature of the client machine the input may be transformed locally or remotely at the interview server. An example of this transformation is utilizing a speech recognition system, which will produce words from a speaker's text. Another example of a transformation is a sound based input system, which lets users speak and the specific phrases are not used as input, but it allows the user to practice for an interview by using spoken language as a continue command. The raw audio is examined for duration, amplitude, and frequencies to detect if the audio input has qualified for real spoken words. In addition, the sound-based input system can be used when requiring an interview with raw audio, without text or speech recognition. Finally, a local machine will be able to support multiple inputs and multiple outputs simultaneously, when supported by the proper hardware and operating system. A networked machine that uses serial or parallel message streams, may queue data serially, but the local machine will be able to utilize the input and output simultaneously, when supported by the proper hardware and operating system.

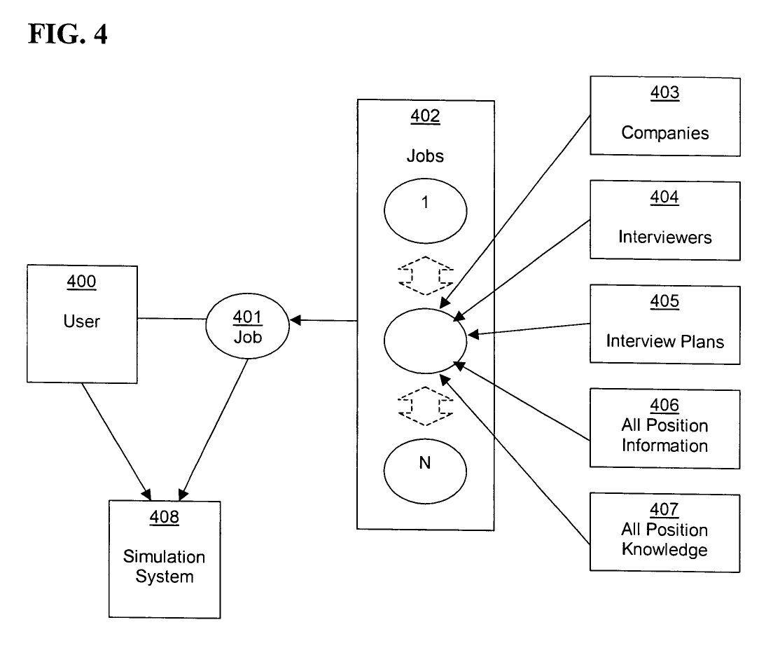

The Interview Discussion Engine: FIG. 3, shows how the software is able to simulate an interview conversation based on a dynamic interview plan and a set of internal expert systems. This allows a user to experience a series of interconnected discussions that create an interview discussion as a whole. The system uses natural language tools to evaluate speech or text input (300). A variety of processing techniques (302) can be used to identify if syntax, vocabulary, and grammar are valid. Although these techniques may not be able to validate all forms of a particular language, the system is often able to identify invalid input and react accordingly. The system capability to react to input is higher than a general purpose language parser because of the focus on interview discussions and supported data. Data files, which are created by an AI (Artificial Intelligence) Editor, provide data to the language processors and expert systems. Since the majority of language data (302) is separated from the code, the system will be able to support interviews in multiple languages such as English, Spanish, French, Italian, and non-Latin languages such as Chinese, Hebrew, Russian, Korean, and others. As already discussed the simulation discussion is controlled by an interconnected set of state machines. A specific set of state machines is initially generated based on an interview plan of the selected job FIG. 4. These state machines (303) know how to handle specific pieces of a conversation such as a greeting stage, resume discussion stage, particular skill review stage, company discussion stage, and other stages. The states know how to transfer control to one another based on a variety of factors including the events of the current interview. Each state machine contains specific logic that defines how to process inputs and outputs in relation to other events which may have occurred during the interview. States are able to share information such as (304) discussion memory, (305) input data, (306) output data, and (307) session data. Memory may include many kinds of knowledge and information from previous interviews. Input data may include pure and processed user input, as well as other information that was gathered or realized about the user. Output data includes data that was spoken to the user and other information that was created during the interview. Session data includes communications information and other environment information.

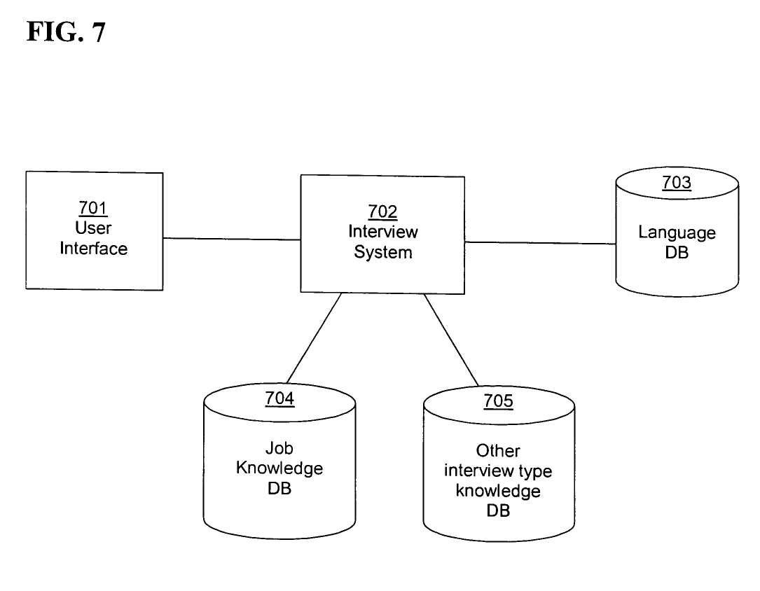

Configurable Language Selection: FIG. 7, depicts how the system is organized in a specific manner to allow a wide range of languages to be supported. A language database (703) is used to store all general information regarding a localization. This will help identify synonyms, pronunciation rules, common phrases, common questions, and other general purpose textual resources. The job knowledge database (704) can also be altered. The job knowledge database has job specific information such as lists and values, but it also contains language specific textual phrases. An example of language specific job knowledge text is a job skill question. The system is flexible and supports multiple languages by changing the language database and the job knowledge database. It is also possible to change only the language DB, have the job knowledge database in one base language and have a base language to target language component. Internally the system supports Unicode based characters, which support a multitude of languages and characters. Consideration should be made for the user interface such as the specific application help system. The interview system (702) may also utilize a set of speech recognition or speech generation components that may require either manual configuration or dynamic selection based on the language mode of the session. The flexible language support also applies to FIG. 9, the call center configurations.

Administration and Integration of Live Interviewers: FIG. 10, shows how human administrators have the ability to directly and remotely control and manage interview servers including the ability to act as a live interviewer thus receiving and controlling any outgoing speech, text, video, and characters that the user is experiencing in the interview. The interview system allows an external program (1003) to hook into the interview system logic (1006) and control some or all of the interview. This can be a useful application if a third party such as a career advisor or employer wish to interview a client remotely. The novelty of this new invention is that the computer generated interview system can manage all or some of the interview, and the administrator may passively monitor, or take control of the interview conversation using the default computer generated imagery for video if required, or completely replace the computer generated interviewer with his or her text, speech, video. It is possible for the administration program to be a local program connected to the interview server, or a remote program accessing the system through a network. This administration program has the ability to monitor and interact with several interview clients simultaneously just as the server logic handles several clients simultaneously. The administration tool will also have the ability to access information about the interviewer such as resume and other application data.

Interview Result Analysis: Once the user has fully completed the interview, the system processes individual and collective responses qualitatively and quantitatively to provide users with analysis, compare candidates, compute rankings, estimate outcomes, provide reports, provide hiring recommendations. The system will use an evaluation and statistics module in the discussion engine to identify trends and problems such as excessive delays while waiting for an answer or problems comprehending a specified percentage of input. The system will also use the job knowledge (406, 407) to identify scores based on answers identified within the discussion engine. Interview jobs reference a job description which specifies what skills are required for each job, as well as what levels of competency are required for each skill. The system will use this information in scoring applicants. Job descriptions also have qualitative factors such as traits, and although some trait questions have clear answers others do not. Sometimes the system will query the user as to the capabilities of a specific skill or trait and log the results of his or her answer. Depending on the job description, a skill may require a certain level of assurance that a user is of a certain skill level. The system will use that information to further ask questions about certain topics. The system will not only provide analysis, but also it will provide reports and any available resume, job application, transcript, audio, and video. Training applications can use the interview analysis to improve interview performance and the analysis can be presented in the form of feedback. Hiring applications or systems may use the interview analysis to match or screen job applicants.

General and Job Specific Discussion Topics: FIG. 4, describes how a user is able to choose a job (401) and how that job has concrete information that is used during an interview by the simulation system (408). A user can choose a job in several ways. One possible method is to have the user select a job from a set of classified ads (402). Internally, each classified ad will contain unique information that will correspond to a company (403), interviewer (404), interview plan (405), position information (406), and job knowledge (407). Companies contain information such as a description, number of employees, industries, culture, benefits, products, interview room environments, and much more. Interviewers are characters that have visual and non-visual characteristics similar to that of company managers, HR, and line managers. Interview plans allow for many different types of interviews, by building an interview agenda that drives the interview and may or may not allow for temporary or permanent deviation of the plan. Interview plans allow the system to have a flexible and realistic interviewing policy. Position information contains data relating to the description of a job, responsibilities of a job, required general skills, required job specific skills and desired qualities including those that are essential, optional, and extra. Position information refers to skill files and job knowledge that contain discussion information that is embedded into the conversation by the expert system. Position information also provides a weighting for each of the position requirements, so that accurate final interview scores can be computed. The system also has a set of secondary skills and traits that may come up during interviews. These are general and behavioral questions. Common general topics include teamwork, goals, flexibility, creativity, initiative, and self-assessment. Each of these topics and many more can be available to the system, and utilized in any interview plan that would like to discuss general topics. In conclusion, the system has the capability to ask and discuss specific or general interview questions.

Configurable Interview Scenarios: The interview system, methods of communications and control, and methods of interview discussion described herein have many uses, such as for automated interviews of applicants and interview training. FIG. 7, demonstrates that the invention presented can also be used for a wide variety of other interviewing applications. Extended application interview systems of value can be created by providing new forms of interview type knowledge (705) in combination with implementing or adjusting any necessary user interface elements (701). For example, the system can be extended to support school admissions interviews, visa application interviews, and performance arts auditions and interviews. So in conclusion, while specific embodiments of the invention have been disclosed in detail, it will be appreciated by those skilled in the art that many modifications and alternatives may be made without deviating from the spirit and scope of the invention defined in claims.

The following is claimed:

1. A system for conducting an employment interview via computer-driven software comprising:
(a) an input system to receive phrases, events, and data from a user;
(b) an output system to provide phrases, events, and data to the user;
(c) one or more logic routines, state machines, and expert systems managing conversation flow;
(d) a communications component to interface with a plurality of direct or indirect users;
(e) a database of job, human resources, and training knowledge;
(f) a database of spoken language information, phrase handling data, and natural language processing data.

2. The system of claim 1, wherein the system allows users to go on generic and position-specific interviews for one or more open positions at one or more employers, and sends data collected from the applicant, data collected throughout the interview system, and an analysis of the user to the employer and/or to the user.

3. The system of claim 1, wherein the system allows users to browse jobs and be matched with them, and takes users on interviews and matches them with a set of employment opportunities based on the user's performance and/or the information provided by the user.

4. The system of claim 1, wherein the system is used to provide an interactive training environment that allows users to go on realistic interactive practice interviews with computer-based characters and gives users interview training, advice, guidance, analysis, feedback, and other career and personal development information.

5. The system of claim 1, wherein images of the interviewer(s) and interviewee(s) are displayed on a computer screen or other viewing device, which give the likeness of a human being or any other desired appearance, in any form of rendering such as photography, video, computer generated imagery, or animation.

6. The system of claim 1, wherein on-screen optionally configurable representations of the interviewer(s) and interviewees(s) animate, change, or move one or more parts of their body to create actions, expressions, gestures, and interactions with other characters or environmental elements.

7. The system of claim 1, wherein a user may interact with, navigate, view, and hear an environment for all of the stages and transitional stages of a real or virtual job interview, including but not limited to leaving a residence, traveling to a job site, waiting in a lobby, entering the interview room or conference room and returning from the interview.

8. The system of claim 1, wherein any user information, recorded audio, or recorded video of the interview discussion can be recorded, digitized, compressed, encrypted, transferred, transmitted, saved, indexed, and reviewed by the user, administrator, advisors, employers, or other interested parties.

9. The system of claim 1, in which some or all of the user information, recorded audio, or recorded video can be transmitted to and from a network server, Internet server, or call center server, which will be accessed by employers or intermediary employment agencies to consider, screen, and evaluate job candidates.

10. The system of claim 1, wherein the system can be used for alternate interview situations, including school admissions interviews, visa application interviews, and performance arts auditions and interviews.

11. A method of implementing communications and control for an employment interview system comprising:
(a) a platform independent data messaging system;
(b) a discussion system that accepts and sends data messages;
(c) a remoting component to support local applications or remote users or remote applications connected by wired or wireless mediums;
(d) a collection of inter-connected user input hardware and software components including but not limited to keyboard, user interface, microphone, speech recognition, mouse, video camera;
(e) a collection of inter-connected user output hardware and software components including but not limited to on screen rendering, closed captioning, speech production, speech playback, language translation, audio speakers;
(f) a collection of inter-connected discussion system inputs including but not limited to text, voice, video, control messages.
(g) a collection of inter-connected discussion system outputs including but not limited to text, pre-recorded speech, rendered speech, control messages.

12. The method in claim 11 wherein the interview can be conducted on a stand-alone computer, portable computing device, networked computer on local area network, networked computer on an intranet, networked computer on a wide area network, networked computer on the Internet, networked computer on a virtual private network, networked computer using a modem, or a wired or wireless telephone with application support.

13. The method in claim 11 wherein the interview can be conducted using voice over an analog or digital audio communications input/output system such as a land line telephone, wireless telephone, hybrid telephone computing device, video phone, or voice over Internet Protocol application, with or without additional mechanical input controls, utilizing any of the supporting communication carriers such as local telephone carriers, long distance telephone carriers, wireless telephone carriers, data over internet carriers, and other capable carriers.

14. The method in claim 11 wherein a user can control a virtual character in an interview environment to perform physical actions and express physical emotions with direct control or indirect control from prior input or configuration.

15. The method in claim 11 wherein a voice or data server supports a plurality of interview clients, a plurality of communication protocols, a plurality of client application types, and a plurality of client side user interfaces.

16. The method in claim 11 whereby the computer code has the ability to use a combination of text, events, audio signals, speech and video signals for input while using a combination of text, audio, pre-recorded speech or computer generated speech and video for output.

17. A method of implementing an employment interview discussion engine comprising:
(a) a database of job, human resources, and training knowledge;
(b) a database of spoken language information, phrase handling data and natural language processing data;
(c) an expert system which can drive a conversation through various stages of an interview plan, including supporting dynamic changes to the discussion topic;
(d) an expert system which can generate phrases, questions, and statements;
(e) an expert system which can respond to input stimuli with phrases relevant to new, previous, or selected previous input;
(f) an input and output system to configure, choose, and facilitate the discussion.

18. The method as recited in claim 17 wherein the expert system and knowledge data is organized in such a way that an interview discussion can occur in a desired language.

19. The method in claim 17 whereby human administrators have the ability to directly or remotely control and manage interview servers including the ability to act as a live interviewer thus receiving and controlling any outgoing speech, text, video, and characters that the user is experiencing in the interview.

20. The method in claim 17 whereby the system processes individual and collective responses qualitatively and quantitatively to provide users with analysis, compare candidates, compute rankings, estimate outcomes, provide reports, and provide hiring recommendations.

21. The method in claim 17 wherein said method can ask general and specific questions corresponding to the job type, job description, required skills, required traits, education, work experience, experience level, industry, interviewer style, user background information, cover letter, and resume.
